(19) United States
(12) Patent Application Publication
(10) Pub. No.: US 2007/0242064 A1
(43) Pub. Date: Oct. 18, 2007

(54) Reflective photo device, electronic apparatus with built-in camera using the device for providing colorimeter and ambient light sensor functions and method thereof

(75) Inventor: Chih-Chia Kuo, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/727,428

(22) Filed: Mar. 27, 2007

(30) Foreign Application Priority Data
Apr. 14, 2006 (TW) 095113341

(51) Int. Cl. G09G 5/00

(52) U.S. Cl. 345/207

(57) ABSTRACT

A reflective photo device, and electronic apparatus with a built-in camera using the device for providing calorimeter and ambient light sensor functions and the method thereof is provided, in which the built-in camera and a reflective photo device are used to provide the colorimeter and ambient light sensor functions. When the built-in camera provides the calorimeter function, the reflecting hold device is hitched on a display of an electronic device. Therefore, a light beam with color block information emitted from the display is received by the built-in camera via the reflecting operation of the reflective photo device. Thereafter, the electronic apparatus processes the light beam received by the built-in camera based on a reflector compensation matrix and a built-in camera calibration matrix to obtain a color profile of the display.

### BACKGROUND OF THE INVENTION

1. Field of the Invention

The present invention relates to built-in camera and, more particularly, to a reflective photo device, an electronic apparatus with a built-in camera using the device for providing colorimeter and ambient light sensor functions, and method thereof.

2. Description of Related Art

Current calorimeters, ambient light sensors, and PC cameras on the market are not sold collectively, but rather as individual elements such that if a user wishes to make use of these device functions simultaneously, he/she must purchase these elements separately, thereby imposing financial burden on the user and bringing operational complexity. There is therefore a need for incorporating the features of the three above-mentioned devices into one, thus greatly reducing production costs and burden on the user.

The functions of colorimeters, ambient light sensors, and PC cameras are briefly described as below.

### Colorimeter

Generally speaking, how colors displayed by personal computers and notebook computers are being perceived by the human eye depends on the performance of the video decoder, the VGA chip, and the LCD (liquid crystal display), with the LCD having the primary impact. That is, as the operational hours of the LCD increase, the output color quality will generally decrease (or at least affected) owing to the aging phenomenon accompanying long hours of use.

Given the impact on color quality by the performance of different elements and the display aging phenomenon, numerous calorimeters have thus been made available on the market to characterize color profile and perform appropriate calibration on the display.

Colorimeters, in addition to being able to sense light in a greater dynamic range than ordinary PC cameras, can also characterize spectral properties of light in XYZ color space coordinates in compliance with the CIE standard colorimetric system (XYZ is a device-independent color space defined by CIE).

### PC Camera

Many electronic apparatuses on the market, such as notebook computers, LCD TVs, mobile phones, and PDAs, now incorporate built-in PC cameras for video conferencing or video chatroom purposes. Due to cost considerations, the sensors in these PC cameras have sensor spectral responsivities that are non-linear with the CIE standard calorimetric system (XYZ system), and thus are often being referred to as “non-colorimetric sensors”. Given such constraints, ordinary PC cameras can only output device dependent colors, as opposed to the device independent colors capable of output by the colorimeters.

### Ambient Light Sensors

Ambient light sensors are provided to automatically adjust brightness of the display to levels best perceivable by the human eyes based on the light detected in the ambient environment. For example, when a user performs presentation in a dim-lit meeting room, the brightness of the display is reduced to thereby prevent discomfort on human eyes caused by high display contrast.

Given that the above described calorimeters, ambient light sensors, and PC cameras are already equipped with light-sensing sensors, and that built-in cameras have become essential to current electronic apparatuses on the market, it is therefore desirable to incorporate the combinational features and functions of colorimeters, ambient light sensors and video capture in a built-in camera. The result of this incorporation is the increase of appeals and competitiveness to these electronic apparatuses.

### SUMMARY OF THE INVENTION

It is one object of the present invention to provide a reflective photo device, an electronic apparatus with a built-in camera using the device for providing colorimeter and ambient light sensor functions and its method, such that the built-in camera and the reflective photo device can be used to perform color measurements.

It is another object of the present invention to provide a reflective photo device, an electronic apparatus with a built-in camera using the device for providing colorimeter and ambient light sensor functions and its method, such that the built-in camera can simultaneously provide functions equivalent of a calorimeter and an ambient light sensor.

According to one aspect, the present invention which achieves these objects relates to a reflective photo device configured to operate with a display of an electronic apparatus of having built-in a receiver and a color calibration system signally connected to the receiver. The reflective photo device includes a first reflective mirror, and a second reflective mirror disposed substantially perpendicular with respect to the first reflective mirror. Operatively, a light emitted from the display reflects off the first reflective mirror and the second reflective mirror and enters the receiver, which responsively generates signals used for color calibration by the color calibration system.

According to another aspect, the present invention which achieves these objects relates to a method of color calibration, which utilizes a receiver and a color calibration system built in an electronic apparatus to calibrate colors output by a display of the electronic apparatus. The method begins by generating a light beam by the display. Then, the light beam is reflected to the receiver utilizing a reflective photo device. Then, in response to receiving the light beam, the receiver generates signals which are used for color calibration by the color calibration system.

According to yet another aspect, the present invention which achieves these objects relates to an electronic apparatus that includes a display, a receiver, a reflective photo device, and a color calibration system. The reflective photo device includes a first reflective mirror and a second reflective mirror. The second reflective mirror is disposed substantially perpendicular with respect to the first reflective mirror. The display emits a light beam, which enters the receiver after reflecting off the first reflective mirror and the second reflective mirror. The receiver generates signals in response to receiving the light beam. The color calibration system performs color calibration using the generated signals.

Other objects, advantages, and novel features of the invention will become more apparent from the following detailed description when taken in conjunction with the accompanying drawings.

### BRIEF DESCRIPTION OF THE DRAWINGS

FIG. 1 is a diagram illustrating the use of a built-in receiver in combination with a reflective photo device for color measurements according to a preferred embodiment of the invention;

FIG. 2 is a side view illustrating a reflective photo device hitching on a display of an electronic apparatus according to a preferred embodiment of the invention;

FIG. 3 is a flow diagram illustrating the formation of a reflector compensation matrix according to a preferred embodiment of the invention;

FIG. 4 is a functional block diagram illustrating the obtaining of a reflector compensation matrix;

FIG. 5 is a flow diagram illustrating the derivation of a built-in camera calibration matrix according to a preferred embodiment of the invention;

FIG. 6 is a functional block diagram illustrating the derivation of a built-in camera calibration matrix according to a preferred embodiment of the invention;

FIG. 7 is a flow diagram illustrating the use of a built-in camera for color characterization according to a preferred embodiment of the invention;

FIG. 8 is a functional block diagram illustrating the use of a built-in camera to perform color characterization according to a preferred embodiment of the invention; and

FIG. 9 is a functional block diagram illustrating the operation of an electronic apparatus according to a preferred embodiment of the invention.

### DETAILED DESCRIPTION OF THE PREFERRED EMBODIMENT

In a preferred embodiment of the present invention, a reflective photo device is provided to allow a receiver built in an electronic apparatus the functions of a calorimeter and ambient light sensor.

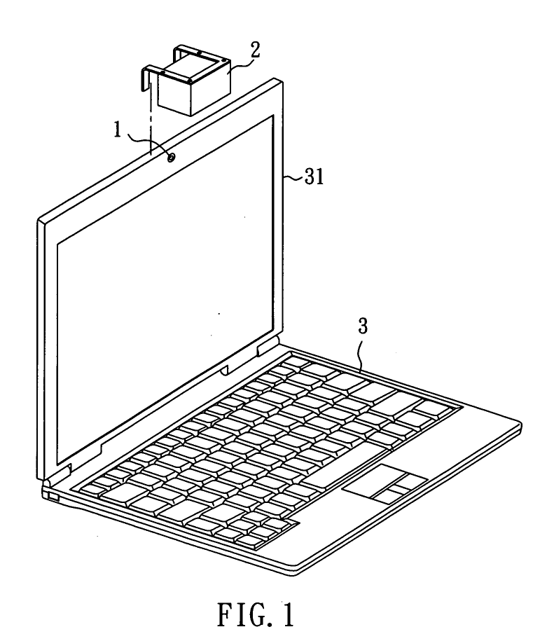

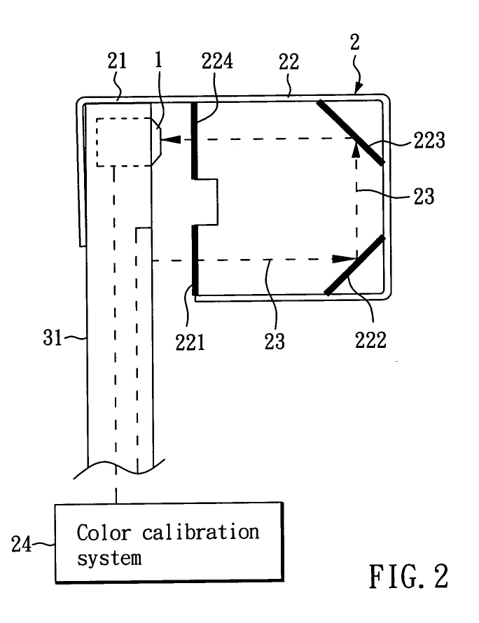

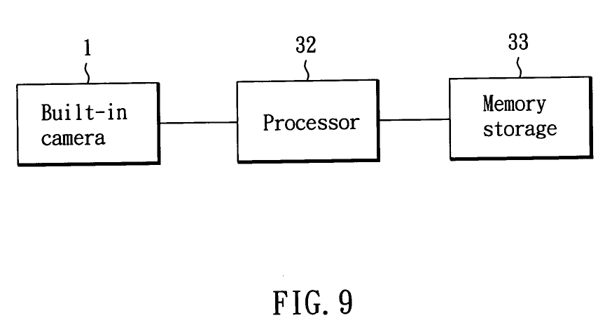

Reference should be made to FIG. 1, FIG. 2 and FIG. 9 for illustration of the reflective photo device. FIG. 1 shows a diagram illustrating the use of a built-in receiver 1 in combination with a reflective photo device 2 for color measurements. FIG. 2 shows a side view of reflective photo device 2 hitching on a display 21 of an electronic apparatus 3. FIG. 9 shows a functional block diagram of electronic apparatus 3.

As shown in FIG. 1, the built-in receiver 1 is disposed on one end of a display 31 of the electronic apparatus 3, and the reflective photo device 2 is hitched on the display 31 at a position corresponding to the built-in receiver 1. In this embodiment, the electronic apparatus 3 is a notebook computer. Still in other embodiments, the electronic apparatus 3 can be a personal computer, a proxy server, or a portable electronic apparatus etc. Of course, in other embodiments, the size of reflective photo device 2 is in proportion with the size of the display to which the reflective photo device 2 is hitched on.

In FIG. 2, via the reflecting operation of reflective photo device 2, the light beam emitted by the display 31 propagates back to the built-in receiver 1 configured on display 31. Receiver 1 is also signally connected to a color calibration system 24. The color calibration system 24 is realized by the hardware or software implemented within electronic apparatus 3. The reflective photo device 2 includes a hitch device 21 and a housing 22 which are respectfully connected to each other. The housing 22 further includes lenses 221 and 224, and reflective mirrors 222 and 223.

Referring to FIG. 9, the electronic apparatus 3 includes a built-in receiver 1, a processor 32, and a memory storage 33. The processor 32 is coupled to the built-in camera 1 and memory storage 33 on each of its ends. The built-in receiver 1 can receive a light beam with first color block information emitted by the display 31. The processor 32 executes a program code stored in the memory storage 33. In this embodiment, the memory storage 33 is a volatile memory, such as SDRAM (Synchronous Dynamic Random Access Memory). Still, in other embodiments, the memory storage 33 can also be a non-volatile memory, such as flash memory. The program code includes the following executions: compensating for a degraded chromaticity signal in the light beam with first color block information utilizing a reflector compensation matrix, for obtaining a compensated chromaticity signal; calibrating the compensated chromaticity signal by utilizing a built-in camera calibration matrix, for obtaining a degraded XYZ chromaticity signal; and obtaining a color profile based on the degraded XYZ chromaticity signal. The detailed execution of the program codes will be later described.

The lens 221 is disposed on an opening of the housing 22, for receiving the light beam emitted by the display 31. The light beam emitted by the display 31 transmits through the lens 221, and then propagates along the light path 23 to arrive at the reflective mirror 222.

The reflective mirror 222 is disposed within the housing 22 at a position corresponding to the lens 221. The above-said transmitted light beam arrives at the reflective mirror 222 at a 45-degree angle with respect to the plane. Thus, the transmitted light beam experiences total internal reflection by the reflective mirror 222 to become a first reflected light beam, which then propagates along the light path 23 to arrive at the reflective mirror 223.

Similarly, the reflective mirror 223 is also disposed within the housing 22, and the reflective mirrors 223 and 222 are disposed substantially perpendicular with respect to each other. When the first reflected light beam arrives at the reflective mirror 223, its angle with respect to the plane of the reflective mirror 223 is 45 degrees. Thus, the first reflected light beam experiences total internal reflection by the reflective mirror 223 to become a second reflected light beam propagating along the light path 23 to arrive at the lens 224.

The lens 224 is disposed on another opening of the housing 22 at a position corresponding to the reflective mirror 223, so as to receive the second reflected light beam reflecting off the reflective mirror 223. The second reflected light beam transmits through the lens 224 and propagates along the light path 23 to arrive at the receiver 1. In FIG. 2, the receiver 1 is a built-in camera. In other embodiments, the receiver 1 can also be a color analyzer.

In this embodiment, in order to prevent scattered light from influencing the sensing result of the receiver, the invention also entails performing irregular surface treatments to the interior of reflective photo device 2 on the non-ideal parts of the light path so as to reduce the interference of the scattered light.

During the reflection operation of the light beam from the display 31 to the receiver 1, the light beam is subject to distortion due to the varying reflection rates of the reflective mirrors 222 and 223 in the reflective photo device 2. Thus, in order to maintain high precision on the color profile of the display 31 as obtained by the built-in receiver 1, the color calibration system 24 is utilized in this preferred embodiment of the invention to provide appropriate compensation to the reflective mirrors 222 and 223 which have varying reflection rates under different wavelengths. Also, since the sensors in an ordinary consumer built-in camera are non-colorimetric sensors, and the sensor spectral responses have non-linear relationships with the CIE XYZ system, the color calibration system 24 must further proceed calibration to the built-in camera. Below describes the compensation on the reflection rate of the reflective mirrors 222 and 223 and the calibration on the built-in camera 3 by the color calibration system 24.

### Reflection Rate Compensation on the Reflective Mirror

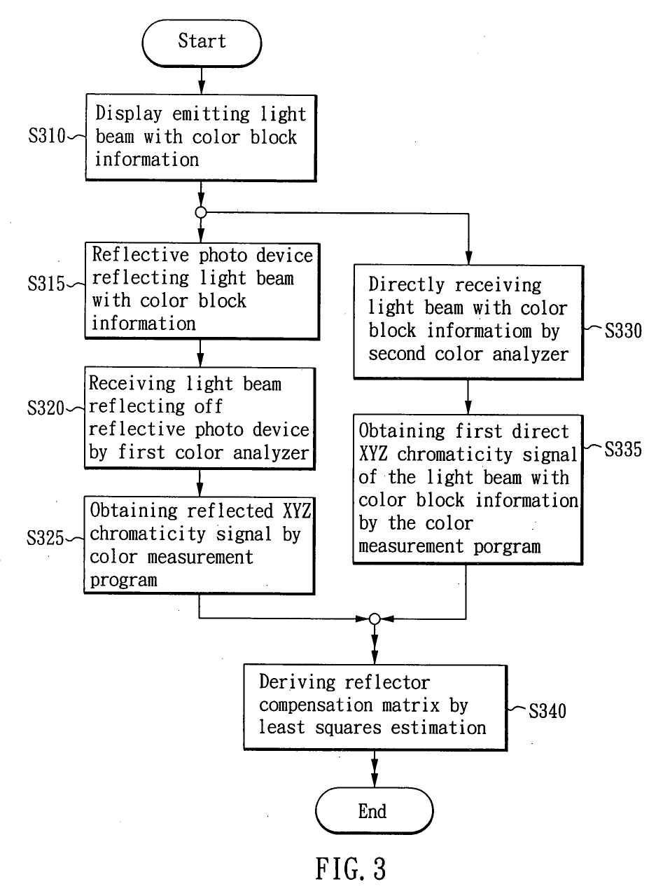

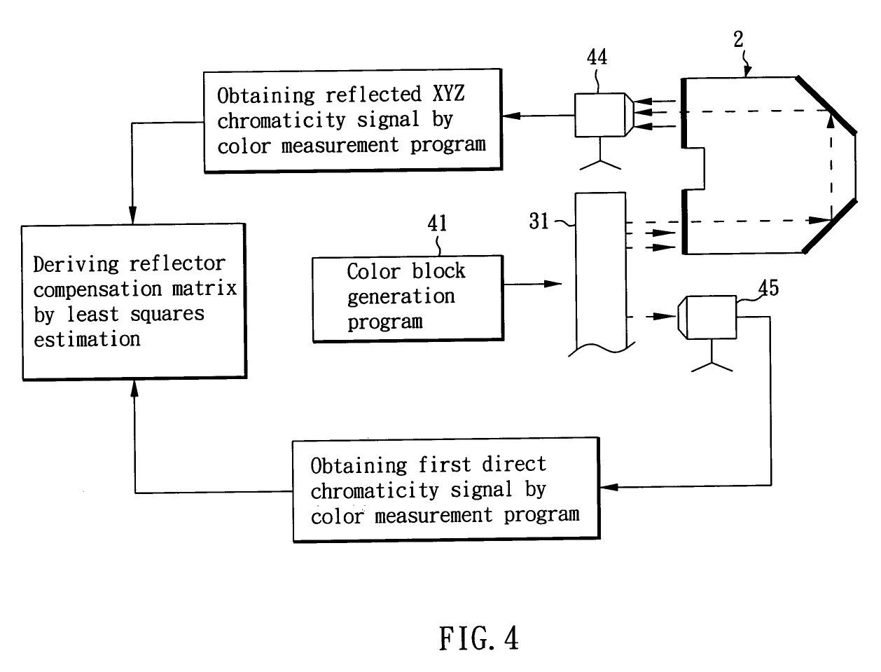

Reference should be made to FIG. 3 and FIG. 4 for illustration of reflection rate compensation on the reflective mirror by the color calibration system 24. FIG. 3 shows a flow diagram illustrating the formation of a reflector compensation matrix. FIG. 4 shows a functional block diagram for obtaining the reflector compensation matrix.

First, a plurality of different digital RGB values is generating using a color block generation program 41 installed on the electronic apparatus 3, such that the to-be-calibrated display 31 of the electronic apparatus 3 displays a plurality of color blocks of different colors, and emits a light beam with color block information (step S310). Then, the color blocks generated by the display 31 are measured both by a first color analyzer 44 indirectly via the reflective photo device 2, and by a second color analyzer 45 directly.

For example, the light beam with color block information emitted by display 31 is reflected by the reflective photo device 2 (step S315) to a direction receivable by a first color analyzer 44 electrically connected to the electronic apparatus 3. Upon receiving the light beam with color block information, first analyzer 44 then sends the detected result to the electronic apparatus 3 (step S320). Thereafter, the results detected by the first color analyzer 44 are processed using the color measurement program installed on the electronic apparatus 3 to obtain a reflected XYZ chromaticity signal (step S325).

As previously mentioned, the light beam with color block information emitted by display 31 is also detected directly (i.e. without going through the reflective photo device) by the second color analyzer 45 which is electrically connected to the electronic apparatus 3 (step S330). After detecting the light beam with color block information, the second color analyzer 45 then sends the detected results to the electronic apparatus 3. The color measurement program stored within the electronic apparatus 3 is then executed on the results detected by second color analyzer 45 to obtain a first direct XYZ chromaticity signal (step S335).

After obtaining the reflected XYZ chromaticity signal (having a plural sets of reflected XYZ values) and the first direct XYZ chromaticity signal (having a plural sets of direct XYZ values), a reflector compensation matrix for the reflective mirrors within the reflective photo device 2 is derived using least squares estimation and a 3×3 matrix (step S340). In this embodiment, a first-order model is used to map the corresponding relationship between the direct XYZ values and the reflected XYZ values and obtain the reflector compensation matrix. Still, in other embodiments, higher-order models, neural networks, and other methods of linear computations can also be used.

### Built-in Camera Calibration

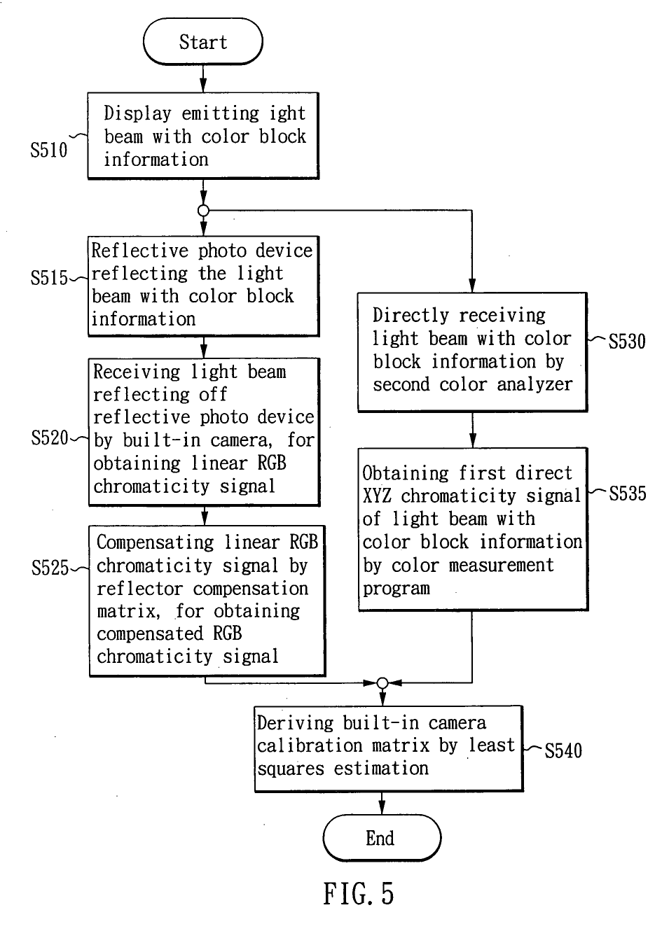

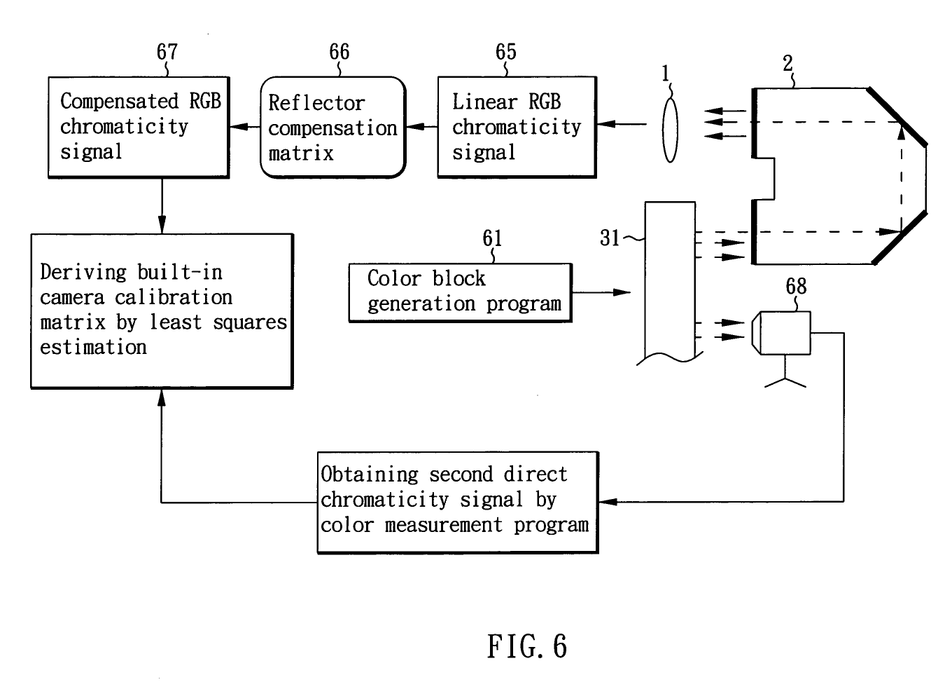

Reference should be made to FIG. 5 and FIG. 6 for illustration of calibration done on built-in camera by color calibration system 24. FIG. 5 shows a flow diagram illustrating the derivation of a built-in camera calibration matrix. FIG. 6 shows a functional block diagram illustrating the derivation of the built-in camera calibration matrix.

Similar to the above-described sequence, a plurality of different digital RGB values is generated by color block generation program 61, such that display 31 displays a plurality of color blocks of different colors and emits a light beam with color block information (step S510).

Next, the color blocks generated by the display 31 are detected by the built-in camera 1 via the reflective photo device 2. That is, the reflective photo device 2 is configured such that the light beam with color block information emitted by display 31 (step S515) can be reflected and received by the built-in camera 1 disposed in the electronic apparatus 3. The built-in camera 1 receives the light beam with color block information and converts this light signal into an electrical signal, which is then digitized for obtaining a linear RGB chromaticity signal 65 (step S520). Then, the linear RGB chromaticity signal 65 is compensated using the earlier obtained reflector compensation matrix 66, for obtaining a compensated RGB chromaticity signal 67 (step S525).

The light beam with color block information emitted by display 31 is also detected directly by the third color analyzer 68, which is electrically connected to electronic apparatus 3 (step S530). The third color analyzer 68 then sends the detected results to electrical apparatus 3. The results of the light beam with color block information detected by the third color analyzer 68 is then processed by the color measurement program installed on the electronic apparatus 3 to obtain a second direct XYZ chromaticity signal (step 535).

Then, after obtaining the compensated the RGB chromaticity signal 67 and the second direct XYZ chromaticity signal from steps S525 and S535, respectively, a built-in camera calibration matrix is derived again using 3×3 matrix and least squares estimation (step S540).

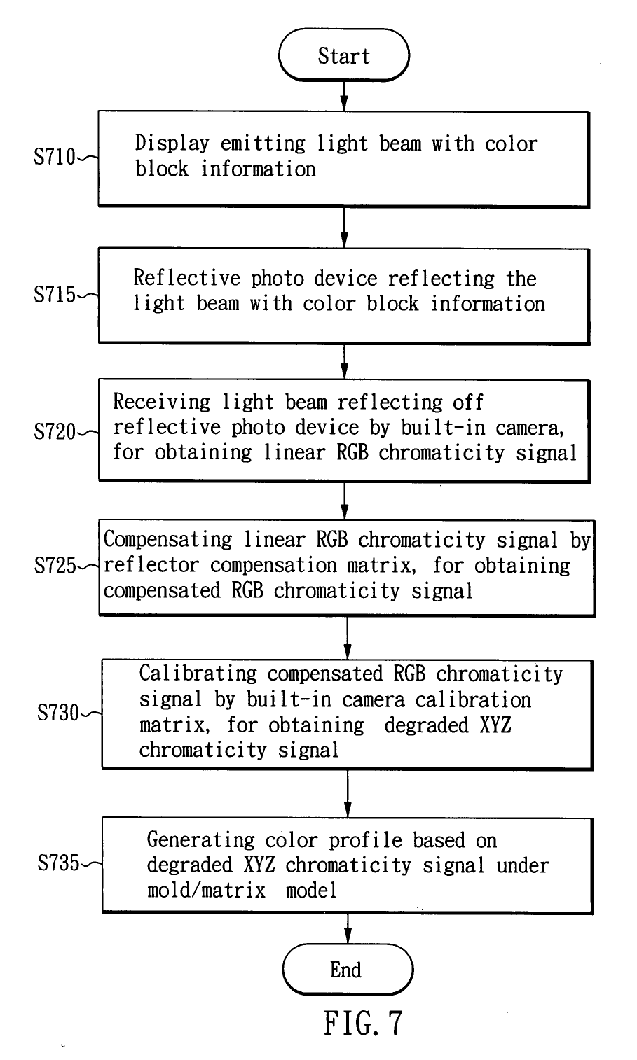

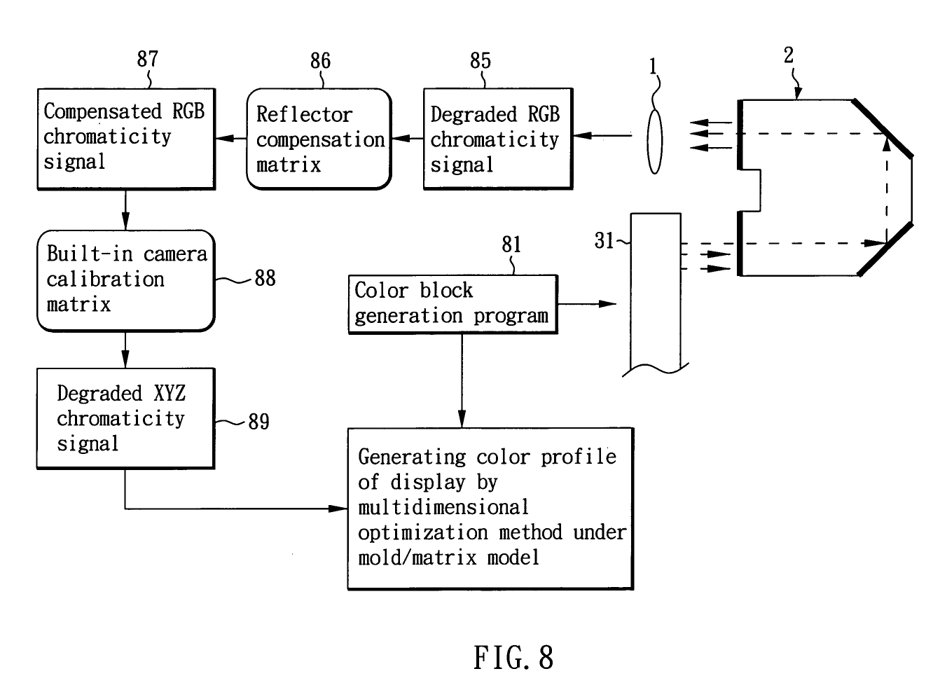

The invention is especially applicable in the current market abundant of LCDs (Liquid Crystal Displays). That is, the backlights of LCDs encounter aging problems which undermine display quality after a period of use (e.g. 2 years). Thus, a user who is very concerned with color output quality can make use of the built-in camera and the reflective photo device provided by the embodiment of the present invention to perform color characterization (to obtain a color profile) and color calibration on such displays with aging backlights. Additionally, the reflector compensation matrix and built-in camera calibration matrix can be configured into the electronic apparatus during the production stage so that the user can simply use the built-in camera to perform color characterization and calibration on the display, and the process of which is shown in FIGS. 7 and 8.

FIG. 7 and FIG. 8 respectively show a flow diagram and a functional block diagram illustrating the use of a built-in camera for color characterization. First, a color block generation program 81 installed on electronic apparatus 3 generates a plurality of varying digital RGB values, based on which the to-be-calibrated display 31 then can display color blocks of varying colors and emit a light beam with color block information (step S710).

Next, the color blocks generated by display 31 are detected by built-in camera 1 via reflective photo device 2. That is, the light beam with color block information emitted by display 31 is reflected by the reflective photo device 2 (step S715) in a manner such that the built-in camera 1 can receive the light beam with color block information to obtain a degraded RGB chromaticity signal 85 (step S720). Then, the degraded RGB chromaticity signal 85 is compensated using the earlier obtained reflector compensation matrix 86, for obtaining a compensated RGB chromaticity signal 87 (step S725).

Next, the compensated RGB chromaticity signal 87 is calibrated using the built-in camera calibration matrix 88 and converted into a degraded XYZ chromaticity signal 89 (step S730). Finally, the corresponding three-dimensional relationship between the digital RGB values and the degraded XYZ chromaticity signals 89 generated by color block generation program 81 is then parameterized using a multidimensional optimization method (e.g. Powell multidimensional optimization) to obtain a color profile of the display 31 with aging phenomenon. The color profile of the display can include gamut, tone reproduction curve, and white/dark point chromaticity etc.

In addition to the functionality of a calorimeter, the built-in camera presented by the preferred embodiment of the present invention also provides the functionality of an ambient light sensor. Contrary to a traditional ambient light sensor which often includes only one sensing element, the built-in camera the embodiment of the present invention includes a sensing array that can obtain brightness distribution of light within a pre-determined range. The brighter and darker brightness distributions within that predetermined range can then be used to derive a simultaneous contrast ratio, in which said ratio in combination with the maximum brightness of the display collectively forms the basis for auto brightness calibration by the electronic apparatus 3 on the display, and thus serving the purpose of an ambient light sensor.

An example is here shown to better illustrate the process of color calibration. The color profile generated by the built-in camera specifically for the display holds record of the display maximum brightness. Thus, with reference to and while not exceeding this maximum brightness, the built-in camera 1 then senses the brightness of the light in the ambient environment by first converting the RGB chromaticity signal obtained by the built-in camera into a XYZ chromaticity signal utilizing the built-in camera calibration matrix, and extracting the Y value (luminance) from the XYZ chromaticity signal. Then, using the Y value as reference, an adequate display brightness value is obtained from a reference brightness table, such as one shown below. The electronic apparatus 3 therefore adjusts brightness of the display based on the adequate display brightness value obtained.

| Typical Operating | Maximum Brightness | |
|---|---|---|
| Environment | (cd/m²) | Simultaneous Contrast |
| Movie Theater | 40 | 80:1 |
| Living Room | 100 | 20:1 |
| Office | 200 | 5:1 |

As described above, the embodiment of the invention provides calorimeter and ambient light sensor functions to the built-in camera by using a reflective photo device working in cooperation therewith. The embodiment of the invention also reduces distortion on the light signal caused by the different reflection rates of the reflective mirror in the reflective photo device while under different wavelengths, by providing a reflector compensation matrix to compensate the distorted light signal. Additionally, the embodiment of the invention improves the non-linearity existed between the sensor spectral responsivities of the built-in camera and the CIE standard calorimetric system by using a built-in camera calibration matrix to calibrate the built-in camera, and thus achieving the functionality of a calorimeter.

Although the embodiment of the present invention has been explained in relation to its preferred embodiment, it is to be understood that many other possible modifications and variations can be made without departing from the spirit and scope of the invention as hereinafter claimed.

What is claimed is:

1. A reflective photo device configured to operate with a display of an electronic apparatus of having built-in a receiver and a color calibration system signally connected to said receiver, the reflective photo device comprising:
a first reflective mirror; and
a second reflective mirror disposed substantially perpendicular with respect to the first reflective mirror,
wherein a light beam emitted from the display reflects off the first reflective mirror and the second reflective mirror and enters the receiver, which responsively generates signals used for color calibration by the color calibration system.

2. The reflective photo device as claimed in claim 1, wherein the receiver is a built-in camera.

3. The reflective photo device as claimed in claim 2, wherein the built-in camera senses a RGB chromaticity signal within a pre-determined range and converts the RGB chromaticity signal into a XYZ chromaticity signal via a built-in camera calibration matrix, for obtaining the luminance of the light received by the built-in camera via the Y value of the XYZ chromaticity signal.

4. The reflective photo device as claimed in claim 1 further comprising a first lens and a second lens, the light emitted from the display passing through the first lens to arrive at the first reflective mirror, the light reflecting off the second reflective mirror passing through the second lens to arrive at the receiver.

5. The reflective photo device as claimed in claim 4 further comprising a hitch device and a housing, the hitch device and the housing being respectfully connected to each other, the first lens, the first reflective mirror, the second reflective mirror, and the second lens being disposed within the housing.

6. A method of color calibration, which utilizes a receiver and a color calibration system built in an electronic apparatus to calibrate colors output by a display of the electronic apparatus, the method comprising the steps of:
generating a light beam by the display;
reflecting the light beam to the receiver utilizing a reflective photo device; and
performing color calibration utilizing the color calibration system based on signals generated by the receiver in response to the receiver receiving the light beam.

7. The method as claimed in claim 6, wherein the color calibration system uses the receiver to receive the light beam with first color block information, and the step of performing color calibration comprises:
compensating a degraded chromaticity signal in the light beam with first color block information utilizing a reflector compensation matrix, for obtaining a compensated chromaticity signal;
calibrating the compensated chromaticity signal utilizing a built-in camera calibration matrix, for obtaining a degraded XYZ chromaticity signal; and
generating a color profile based on the degraded XYZ chromaticity signal.

8. The method as claimed in claim 7, wherein generating the color profile based on the degraded XYZ chromaticity signal is performed under a mold/matrix model.

9. The method as claimed in claim 7, wherein the first color block has a plurality of digital RGB values.

10. The method as claimed in claim 9, wherein the color profile is generated utilizing an optimization method by parameterizing corresponding three-dimensional relationship between the plurality of digital RGB values and the degraded XYZ chromaticity signals.

11. The method as claimed in claim 7, wherein the reflector compensation matrix is derived via the steps of:
generating a second color block, for providing a light beam corresponding to the second color block;
reflecting the light beam corresponding to the second color block utilizing the reflective photo device for receiving by a first color analyzer, for obtaining a reflected XYZ chromaticity signal;
receiving the light beam corresponding to the second color block utilizing a second color analyzer, for obtaining a first direct XYZ chromaticity signal; and
applying a least squares estimation on the reflected XYZ chromaticity signal and the first direct XYZ chromaticity signal, for deriving the reflector compensation matrix.

12. The method as claimed in claim 7, wherein the built-in camera calibration matrix is derived via the steps of:
generating a third color block, for providing a light beam corresponding to the third color block;
reflecting the light beam corresponding to the third color block off the reflective photo device for receiving by the built-in camera, for obtaining a linear RGB chromaticity signal;
compensating the linear RGB chromaticity signal by utilizing the reflector compensation matrix, for obtaining a compensated RGB chromaticity signal;
receiving the light beam corresponding to the third color block utilizing a third color analyzer, for obtaining a second direct XYZ chromaticity signal; and
applying a least squares estimation on the compensated RGB chromaticity signal and the second direct XYZ chromaticity signal, for deriving the built-in camera calibration matrix.

13. An electronic apparatus comprising:
a display for emitting a light beam;
a receiver;
a reflective photo device for comprising a first reflective mirror and a second reflective mirror disposed substantially perpendicular with respect to the first reflective mirror, the light beam entering the receiver after reflecting off the first reflective mirror and the second reflective mirror, the receiver generating signals in response to receiving the light beam; and
a color calibration system for performing color calibration using the signals generated by the receiver.

14. The electronic apparatus as claimed in claim 13, wherein the color calibration system comprises:
a processor, coupled to the receiver, for executing a program code; and
a memory storage, coupled to the processor, for storing the program code; wherein the program code comprises:
compensating a degraded chromaticity signal in the light beam with first color block information utilizing a reflector compensation matrix, for obtaining a compensated chromaticity signal;
calibrating the compensated chromaticity signal by utilizing a built-in camera calibration matrix, for obtaining a degraded XYZ chromaticity signal; and
generating a color profile based on the degraded XYZ chromaticity signal.

15. The electronic apparatus as claimed in claim 13, wherein the receiver is a built-in camera.

16. The electronic apparatus as claimed in claim 15, wherein the built-in camera senses a RGB chromaticity signal within a pre-determined range and converts the RGB chromaticity signal into a XYZ chromaticity signal via a built-in camera calibration matrix, for obtaining the luminance of the light received by the built-in camera via the Y value of the XYZ chromaticity signal.

17. The electronic apparatus as claimed in claim 14, wherein the reflective photo device further comprises:
a hitch device;
a housing respectfully connected to the hitch device;
a first lens for receiving the light beam emitted by the display; and
a second lens, for receiving the light beam reflecting off the second reflective mirror;
wherein the first lens, the first reflective mirror, the second reflective mirror, and the second lens are disposed within the housing.

18. The electronic apparatus as claimed in claim 14, wherein the processor of the color calibration system generates the color profile based on the degraded XYZ chromaticity signal under a mold/matrix model.

19. The electronic apparatus as claimed in claim 14, wherein the first color block has a plurality of digital RGB values.

20. The electronic apparatus as claimed in claim 18, wherein the processor generates the color profile utilizing an optimization method by parameterizing corresponding three-dimensional relationship between the plurality of digital RGB values and the degraded XYZ chromaticity signals.
